(19) United States
(12) Patent Application Publication
(10) Pub. No.: US 2009/0229575 A1
(43) Pub. Date: Sep. 17, 2009

(54) COUPLING DEVICE

(76) Inventors: Edoardo Giorgetti, Rosignano Marittimo (IT); Massimo Latini, Empoli (IT); Daniel Marc, Livorno (IT); Giandomenico Serra, Pisa (IT)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/371,668

(22) Filed: Feb. 16, 2009

(30) Foreign Application Priority Data
Feb. 19, 2008 (EP) 08003045

(51) Int. Cl. F02M 61/14; F16L 39/00; B23P 11/00

(52) U.S. Cl. 123/470; 285/318; 29/888.01

(57) ABSTRACT

Coupling device (50) for hydraulically and mechanically coupling a fuel injector (20) to a fuel rail (14) of a combustion engine (22), the fuel injector (20) having a central longitudinal axis (L), the coupling device (50) having a fuel injector cup (30) being designed to be hydraulically coupled to the fuel rail (14) and to engage a fuel inlet portion (24) of the fuel injector (20), a first ring element (36) being fixedly coupled to the fuel injector cup (30), and a second ring element (38) being fixedly coupled to the fuel injector (20) and being fixedly coupled to the first ring element (36) to retain the fuel injector (20) in the fuel injector cup (30) in direction of the central longitudinal axis (L).

### CROSS-REFERENCE TO RELATED APPLICATIONS

This application claims priority to EP Patent Application No. 08003045 filed Feb. 19, 2008, the contents of which is incorporated herein by reference in its entirety.

### TECHNICAL FIELD

The invention relates to a coupling device for hydraulically and mechanically coupling a fuel injector to a fuel rail of a combustion engine.

### BACKGROUND

Coupling devices for hydraulically and mechanically coupling a fuel injector to a fuel rail are in widespread use, in particular for internal combustion engines. Fuel can be supplied to an internal combustion engine by the fuel rail assembly through the fuel injector. The fuel injectors can be coupled to the fuel injector cups in different manners.

In order to keep pressure fluctuations during the operation of the internal combustion engine at a very low level, internal combustion engines are supplied with a fuel accumulator to which the fuel injectors are connected and which has a relatively large volume. Such a fuel accumulator is often referred to as a common rail.

Known fuel rails comprise a hollow body with recesses in form of fuel injector cups, wherein the fuel injectors are arranged. The connection of the fuel injectors to the fuel injector cups that supply the fuel from a fuel tank via a low or high-pressure fuel pump needs to be very precise to get a correct injection angle and a sealing of the fuel.

### SUMMARY

According to various embodiments, a coupling device for hydraulically and mechanically coupling a fuel injector to a fuel rail can be designed which is simply to be manufactured and which facilitates a reliable and precise connection between the fuel injector and the fuel injector cup without a resting of the fuel injector on the cylinder head.

According to an embodiment, a coupling device for hydraulically and mechanically coupling a fuel injector to a fuel rail of a combustion engine, the fuel injector having a central longitudinal axis, may comprise—a fuel injector cup being designed to be hydraulically coupled to the fuel rail and to engage a fuel inlet portion of the fuel injector,—a first ring element being fixedly coupled to the fuel injector cup, and—a second ring element being fixedly coupled to the fuel injector and being fixedly coupled to the first ring element to retain the fuel injector in the fuel injector cup in direction of the central longitudinal axis.

According to a further embodiment, the fuel injector cup may comprise a groove, a first snap ring being arranged in the groove and being designed to fixedly couple the first ring element to the fuel injector cup. According to a further embodiment, the groove and the first snap ring can be arranged and designed to form a positive fitting coupling between the first ring element and the fuel injector cup which is designed to prevent a movement of the first ring element relative to the fuel injector cup at least in a first direction of the central longitudinal axis. According to a further embodiment, a welding seam may be arranged between the first ring element and the fuel injector cup to fixedly couple the first ring element to the fuel injector cup. According to a further embodiment, the first ring element can be in one part with the fuel injector cup. According to a further embodiment, the fuel injector may comprise a groove, a second snap ring being arranged in the groove of the fuel injector and is designed to fixedly couple the second ring element to the fuel injector. According to a further embodiment, the groove of the fuel injector and the second snap ring can be arranged and designed to form a positive fitting coupling between the second ring element and the fuel injector which is designed to prevent a movement of the second ring element relative to the fuel injector at least in a second direction of the central longitudinal axis opposing the first direction of the central longitudinal axis. According to a further embodiment, a welding seam can be arranged between the second ring element and the fuel injector to fixedly couple the second ring element to the fuel injector. According to a further embodiment, the second ring element can be in one part with the fuel injector. According to a further embodiment, one of the ring elements can be designed and arranged to enable a screw coupling between the ring elements.

### BRIEF DESCRIPTION OF THE DRAWINGS

Embodiments are explained in the following with the aid of schematic drawings. These are as follows:

FIG. 1 an internal combustion engine in a schematic view,

FIG. 2 a longitudinal section through a fuel injector,

FIG. 3 a longitudinal section through a first embodiment of a coupling device,

FIG. 4 a longitudinal section through a second embodiment of the coupling device, and

FIG. 5 a longitudinal section through a third embodiment of the coupling device.

Elements of the same design and function that occur in different illustrations are identified by the same reference character.

### DETAILED DESCRIPTION

The various embodiments are distinguished by a coupling device for hydraulically and mechanically coupling a fuel injector to a fuel rail of a combustion engine, the fuel injector having a central longitudinal axis, the coupling device comprising

a fuel injector cup being designed to be hydraulically coupled to the fuel rail and to engage a fuel inlet portion of the fuel injector, a first ring element being fixedly coupled to the fuel injector cup, and a second ring element being fixedly coupled to the fuel injector and being fixedly coupled to the first ring element to retain the fuel injector in the fuel injector cup in direction of the central longitudinal axis.

This has the advantage that a fast and secure coupling of the fuel injector in the fuel injector cup is possible. Furthermore, the coupling of the fuel injector with the fuel rail by the ring elements of the fuel injector and the fuel injector cup allows an assembly of the fuel injector and the fuel rail without a further metallic contact between the fuel injector and further parts of the combustion engine. Consequently, a noise transmission between the fuel injector and further parts of the combustion engine can be kept small.

In an embodiment the fuel injector cup comprises a groove, and a first snap ring is arranged in the groove and is designed to fixedly couple the first ring element to the fuel injector cup. This may allow a simple construction of the coupling device which enables to carry out a fast and secure but reversible coupling of the first ring element to the fuel injector cup.

In a further embodiment the groove and the first snap ring are arranged and designed to form a positive fitting coupling between the first ring element and the fuel injector cup which is designed to prevent a movement of the first ring element relative to the fuel injector cup at least in a first direction of the central longitudinal axis. By this a secure coupling of the first ring element to the fuel injector cup is enabled.

In a further embodiment the coupling device has a welding seam which is arranged between the first ring element and the fuel injector cup to fixedly couple the first ring element to the fuel injector cup. This allows a simple construction of the coupling device and carrying out a very secure coupling of the fuel injector to the fuel injector cup.

In a further embodiment the first ring element is in one part with the fuel injector cup. This has the advantage that a very secure coupling of the fuel injector to the fuel injector cup is possible. Furthermore, a simple machining of the first ring element together with the fuel injector cup is possible.

In a further embodiment the fuel injector comprises a groove, a second snap ring is arranged in the groove of the fuel injector and is designed to fixedly couple the second ring element to the fuel injector. This may allow a simple construction of the coupling device which enables to carry out a fast and secure but reversible coupling of the second ring element to the fuel injector.

In a further embodiment the groove of the fuel injector and the second snap ring are arranged and designed to form a positive fitting coupling between the second ring element and the fuel injector which is designed to prevent a movement of the second ring element relative to the fuel injector at least in a second direction of the central longitudinal axis opposing the first direction of the central longitudinal. By this a secure coupling of the second ring element to the fuel injector is enabled.

In a further embodiment a welding seam is arranged between the second ring element and the fuel injector to fixedly couple the second ring element to the fuel injector. This allows a simple construction of the coupling device and carrying out a very secure coupling of the fuel injector to the fuel injector cup.

In a further embodiment the second ring element is in one part with the fuel injector. This has the advantage that a very secure coupling of the fuel injector to the fuel injector cup is possible. Furthermore, a simple machining of the second ring element together with the fuel injector is possible.

In a further embodiment one of the ring elements is designed and arranged to enable a screw coupling between the ring elements. This has the advantage that a simple construction of the coupling device is possible which allows carrying out a fast and secure coupling of the fuel injector in the fuel injector cup. Furthermore, a defined positioning of the fuel injector relative to the fuel injector cup in axial and circumferential direction is enabled.

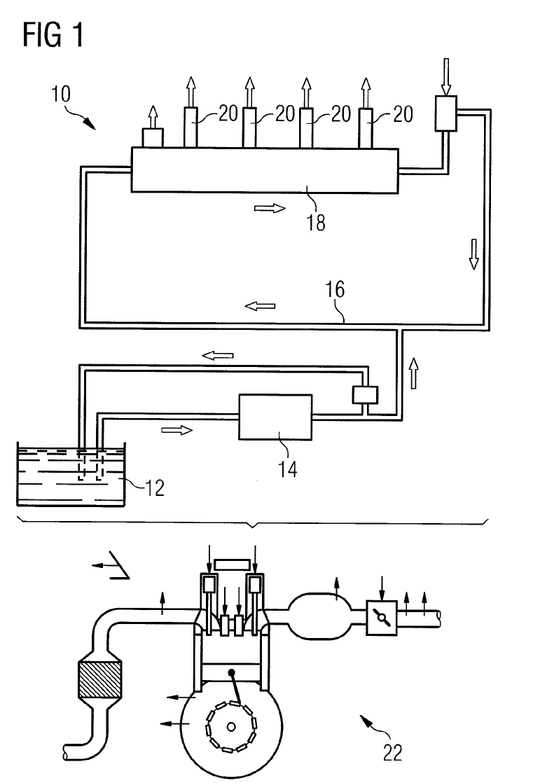

A fuel feed device 10 is assigned to an internal combustion engine 22 (FIG. 1) which can be a diesel engine or a gasoline engine. It includes a fuel tank 12 that is connected via a first fuel line to a fuel pump 14. The output of the fuel pump 14 is connected to a fuel inlet 16 of a fuel rail 18. In the fuel rail 18, the fuel is stored for example under a pressure of about 200 bar in the case of a gasoline engine or of about 2,000 bar in the case of a diesel engine. Fuel injectors 20 are connected to the fuel rail 18 and the fuel is fed to the fuel injectors 20 via the fuel rail 18.

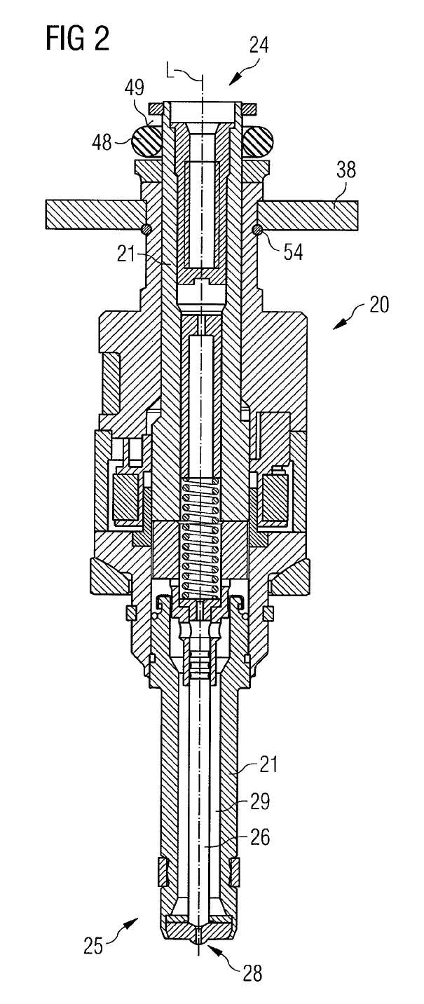

FIG. 2 shows the fuel injector 20. The fuel injector 20 has a fuel injector body 21 and is suitable for injecting fuel into a combustion chamber of the internal combustion engine 22. The fuel injector 20 has a fuel inlet portion 24 and a fuel outlet portion 25.

Furthermore, the fuel injector 20 comprises a valve needle 26 taken in a cavity 29 of the fuel injector body 21. On a free end of the fuel injector 20 an injection nozzle 28 is formed which is closed or opened by an axial movement of the valve needle 26. In a closing position a fuel flow through the injection nozzle 28 is prevented. In an opening position fuel can flow through the injection nozzle 28 into the combustion chamber of the internal combustion engine 22.

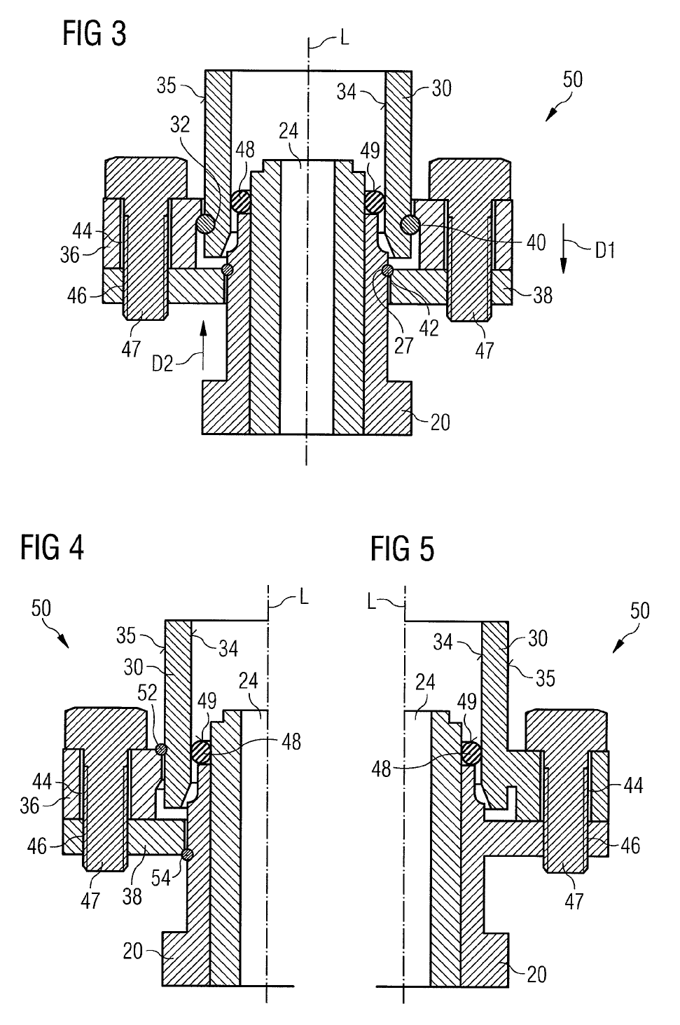

FIGS. 3 to 5 show different embodiments of a coupling device 50 which comprises the fuel injector 20. The coupling device 50 is designed to be coupled to the fuel rail 18 of the internal combustion engine 22. The coupling device 50 has a fuel injector cup 30, a first ring element 36 and a second ring element 38. The fuel injector cup 30 comprises an inner surface 34 and an outer surface 35 and is hydraulically coupled to the fuel rail 18. Furthermore, the fuel injector cup 30 is in engagement with the fuel inlet portion 24 of the fuel injector 20. The fuel inlet portion 24 of the fuel injector 20 comprises a sealing ring 48 with an outer surface 49.

The first ring element 36 is fixedly coupled to the fuel injector cup 30. The second ring element is fixedly coupled to the fuel injector 20. Preferably, the first ring element 36 has a through hole 44 and the second ring element 38 has a thread 46. The first ring element 36 and the second ring element 38 are fixedly coupled with each other by a screw 47 which is received by the through hole 44 of the first ring element 36 and is screwed into the thread 46 of the second ring element 38.

As the first ring element 36 is fixedly coupled to the fuel injector cup 30, the second ring element 38 is fixedly coupled to the fuel injector 20 and the first ring element 36 is fixedly coupled to the second ring element 38 by the screw 47, the fuel injector 20 is retained in the fuel injector cup 30 in direction of the central longitudinal axis L.

FIG. 3 shows an embodiment of the coupling device 50 wherein the fuel injector cup 30 has a groove 32 and the fuel injector 20 has a groove 27. The coupling device 50 has a first snap ring 40 which is arranged in the groove 32 of the fuel injector cup 30 and a second snap ring 42 which is arranged in the groove 27 of the fuel injector 20. The first ring element 36 is in engagement with the first snap ring 40 and the second ring element is in engagement with the second snap ring 42.

The first snap ring 40 enables a positive fitting coupling between the first ring element 36 and the fuel injector cup 30 to prevent a movement of the first ring element 36 relative to the fuel injector cup 30 in a first direction D1. The second snap ring 42 enables a positive fitting coupling between the second ring element 38 and the fuel injector 20 to prevent a movement of the second ring element 38 relative to the fuel injector 20 in a second direction D2. The first direction D1 and the second direction D2 are opposing directions of the central longitudinal axis L.

In the following, the assembly and disassembly of the fuel injector 20 with the fuel injector cup 30 according to the embodiment of FIG. 3 will be described:

For assembling, the first ring element 36 is shifted over the fuel injector cup 30, the first snap ring 40 is shifted into the groove 32 of the fuel injector cup 30, the second ring element 38 is shifted over the fuel injector 20 and the second snap ring 42 is shifted into the groove 27 of the fuel injector 20. Additionally, the first ring element 36 is shifted on the fuel injector cup 30 until it is in a positive fitting coupling with the fuel injector cup 30 to prevent a movement of the first ring element 36 relative to the fuel injector cup 30 in the first direction D1 of the central longitudinal axis L. Furthermore, the second ring element 38 is shifted over the fuel injector 20 until it is in a positive fitting coupling with the fuel injector 20 to prevent a movement of the second ring element 38 relative to the fuel injector 20 in the second direction D2 of the central longitudinal axis L opposing the first direction Dl of the central longitudinal axis L.

Furthermore, the fuel inlet portion 24 of the fuel injector 20 is shifted into the fuel injector cup 30 in a way that the first ring element 26 and the second ring element 38 are in engagement with each other. Then, the screws 47 are screwed into the threads 36 of the second ring element 38 and a state as shown in FIG. 3 is obtained. As can be seen in FIG. 3, the inner surface 34 of the fuel injector cup 30 is in sealing engagement with the outer surface 49 of the sealing ring 48. After the assembly process fuel can flow through the fuel injector cup 30 into the fuel inlet portion 24 of the fuel injector 20 without fuel leakage.

To disassemble the fuel injector 20 from the fuel injector cup 30, the screws 47 are removed and the fuel injector 20 can be shifted away from the fuel injector cup 30 in axial direction and the fuel injector cup 30 and the fuel injector 20 can be separated from each other.

In the embodiment of FIG. 4 the coupling device 50 has a welding seam 52 between the first ring element 36 and the fuel injector cup 30 and a welding seam 54 between the second ring element 38 and the fuel injector 20. By the welding seams 52, 54 the ring elements 36, 38 are rigidly coupled to the fuel injector cup 30 and the fuel injector 20 respectively.

In the following the assembly and disassembly of the fuel injector 20 with the fuel injector cup 30 of the embodiment of FIG. 4 will be described:

For assembling the fuel injector 20 with the fuel injector cup 30, the first ring element 36 is shifted over the fuel injector cup 30 and the welding seam 52 is attached to fixedly couple the first ring element 36 to the fuel injector cup 30. Furthermore, the second ring element 38 is shifted over the fuel injector 20 and is rigidly coupled to the fuel injector 20 by the welding seam 54. The fuel inlet portion 24 of the fuel injector 20 is pushed into the fuel injector cup 30. By shifting the fuel injector 20 in axial direction into the fuel injector cup 30, the inner surface 34 of the fuel injector cup 30 is in sealing engagement with the outer surface 49 of the sealing ring 48. The screws 47 are screwed into the second ring element 38 as described e embodiment of FIG. 3.

In the embodiment of the coupling device 50 of FIG. 5 the first ring element 36 is in one part with the fuel injector cup 30 and the second ring 38 is in one part with the fuel injector 20. By this a very rigid and very secure coupling between the fuel injector cup 30 and the fuel injector 20 is possible.

For assembling the fuel injector 20 with the fuel injector cup 30 according to the embodiment of FIG. 5, the fuel inlet portion 24 of the fuel injector 20 is pushed into the fuel injector cup 30 and the first ring element 36 and the second ring element 38 are screwed together by the screws 47.

The coupling of the fuel injector 20 with the fuel rail 18 by the ring elements 36, 38 and the screws 47 allows an assembly of the fuel injector 20 and the fuel injector cup 30 without a further metallic contact between the fuel injector 20 and the further parts of the internal combustion engine 22. A sealing between the fuel injector body 21 and a combustion chamber of the internal combustion engine 22 can be carried out by a plastic element, in particular by a PTFE element. Consequently, noise transmission between the fuel injector 20 and further parts of the internal combustion engine can be kept small.

What is claimed is:

1. A coupling device for hydraulically and mechanically coupling a fuel injector to a fuel rail of a combustion engine, the fuel injector having a central longitudinal axis, the coupling device comprising
a fuel injector cup being designed to be hydraulically coupled to the fuel rail and to engage a fuel inlet portion of the fuel injector,
a first ring element being fixedly coupled to the fuel injector cup, and
a second ring element being fixedly coupled to the fuel injector and being fixedly coupled to the first ring element to retain the fuel injector in the fuel injector cup in direction of the central longitudinal axis.

2. The coupling device according to claim 1, wherein the fuel injector cup comprises a groove, a first snap ring being arranged in the groove and being designed to fixedly couple the first ring element to the fuel injector cup.

3. The coupling device according to claim 2, wherein the groove and the first snap ring are arranged and designed to form a positive fitting coupling between the first ring element and the fuel injector cup which is designed to prevent a movement of the first ring element relative to the fuel injector cup at least in a first direction of the central longitudinal axis.

4. The coupling device according to claim 1, wherein a welding seam being arranged between the first ring element and the fuel injector cup to fixedly couple the first ring element to the fuel injector cup.

5. The coupling device according to claim 1, wherein the first ring element is in one part with the fuel injector cup.

6. The coupling device according to claim 1, wherein the fuel injector comprises a groove, a second snap ring being arranged in the groove of the fuel injector and is designed to fixedly couple the second ring element to the fuel injector.

7. The coupling device according to claim 6, wherein the groove of the fuel injector and the second snap ring is arranged and designed to form a positive fitting coupling between the second ring element and the fuel injector which is designed to prevent a movement of the second ring element relative to the fuel injector at least in a second direction of the central longitudinal axis opposing the first direction of the central longitudinal axis.

8. The coupling device according to claim 1, wherein a welding seam is arranged between the second ring element and the fuel injector to fixedly couple the second ring element to the fuel injector.

9. The coupling device according to claim 1, wherein the second ring element is in one part with the fuel injector.

10. The coupling device according to claim 1, wherein one of the ring elements is designed and arranged to enable a screw coupling between the ring elements.

11. A method for hydraulically and mechanically coupling a fuel injector to a fuel rail of a combustion engine, the fuel injector having a central longitudinal axis, comprising the steps of:
designing a fuel injector cup to be hydraulically coupled to the fuel rail and to engage a fuel inlet portion of the fuel injector,
fixedly coupling a first ring element to the fuel injector cup, and
fixedly coupling a second ring element to the fuel injector and to the first ring element to retain the fuel injector in the fuel injector cup in direction of the central longitudinal axis.

12. The method according to claim 11, wherein the fuel injector cup comprises a groove, and wherein the method comprises the step of arranging a first snap ring in the groove being designed to fixedly couple the first ring element to the fuel injector cup.

13. The method according to claim 12, comprising the step of arranging and designing the groove and the first snap ring to form a positive fitting coupling between the first ring element and designing the fuel injector cup to prevent a movement of the first ring element relative to the fuel injector cup at least in a first direction of the central longitudinal axis.

14. The method according to claim 11, comprising the step of arranging a welding seam between the first ring element and the fuel injector cup to fixedly couple the first ring element to the fuel injector cup.

15. The method according to claim 11, wherein the first ring element is in one part with the fuel injector cup.

16. The method according to claim 11, wherein the fuel injector comprises a groove, and the method comprises the step of arranging and designing a second snap ring in the groove of the fuel injector to fixedly couple the second ring element to the fuel injector.

17. The method according to claim 16, comprising the step of arranging and designing the groove of the fuel injector and the second snap ring to form a positive fitting coupling between the second ring element and the fuel injector which is designed to prevent a movement of the second ring element relative to the fuel injector at least in a second direction of the central longitudinal axis opposing the first direction of the central longitudinal axis.

18. The method according to claim 11, comprising the step of arranging a welding seam between the second ring element and the fuel injector to fixedly couple the second ring element to the fuel injector.

19. The method according to claim 11, wherein the second ring element is in one part with the fuel injector.

20. The method according to claim 11, comprising the step of designing and arranging one of the ring elements to enable a screw coupling between the ring elements.
